(19) United States
(12) Patent Application Publication
(10) Pub. No.: US 2016/0066289 A1
(43) Pub. Date: Mar. 3, 2016

(54) HYPERFRAME NUMBER DESYNCHRONIZATION RECOVERY MECHANISM

(71) Applicant: QUALCOMM Incorporated, San Diego, CA (US)

(72) Inventors: Sitaramanjaneyulu Kanamarlapudi, San Diego, CA (US); Arvindhan Kumar, San Diego, CA (US); Chetan Gopalakrishnan Chakravarthy, San Diego, CA (US); Luna Sapna D'Souza, San Diego, CA (US); Liangchi Hsu, San Diego, CA (US)

(21) Appl. No.: 14/678,707

(22) Filed: Apr. 3, 2015

Related U.S. Application Data
(60) Provisional application No. 62/043,227, filed on Aug. 28, 2014.

(51) Int. Cl. H04W 56/00; H04W 76/04

(52) U.S. Cl. CPC H04W 56/001; H04W 76/046; H04W 88/12

(57) ABSTRACT

The disclosure provides for recovering from radio link desynchronization. A network node may determining a first validity rate of a first plurality of protocol data units (PDUs) including a length indicator transmitted over the radio link using ciphering based on a hyperframe number and determining a second validity rate of a second plurality of PDUs without a length indicator transmitted over the radio link using ciphering based on the hyperframe number. The network node may detect desynchronization of the hyperframe number based on the first validity rate and the second validity rate. The network node may initiate a reset procedure to set a new hyperframe number for the radio link. The network node may detect desynchronization when the first validity rate is less than a first threshold, and the second validity rate is greater than or equal to a second threshold.

### CROSS-REFERENCE TO RELATED APPLICATIONS

This application claims priority to U.S. Provisional Application Ser. No. 62/043,227, filed on Aug. 28, 2014, entitled “HYPER-FRAME NUMBER DESYNCHRONIZATION RECOVERY MECHANISM” which is assigned to the assignee hereof and hereby expressly incorporated by reference herein in its entirety.

### BACKGROUND

Aspects of the present disclosure relate generally to wireless communication systems, and more particularly, to synchronization between a device and a network.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

A Radio Link Control (RLC) protocol maintains a connection between a device and a network. The connection may include ciphering to protect data transmitted over the connection. The ciphering may use a ciphering key based in part on frame information. When the frame information between a device and a network becomes desynchronized, the receiving end of the connection may be unable to decipher information transmitted over the connection. In this case, data loss and/or transfer of invalid data may occur, resulting in a poor user experience.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The disclosure provides for recovering from radio link desynchronization. A network node may determine a first validity rate of a first plurality of protocol data units (PDUs) including a length indicator transmitted over the radio link using ciphering based on a hyperframe number, and may determine a second validity rate of a second plurality of PDUs without a length indicator transmitted over the radio link using ciphering based on the hyperframe number. The network node may detect desynchronization of the hyperframe number based on the first validity rate and the second validity rate. For instance, the network node may detect desynchronization when the first validity rate is less than a first threshold, and the second validity rate is greater than or equal to a second threshold. The network node may initiate a reset procedure to set a new hyperframe number for the radio link.

In an aspect, the disclosure provides a method for recovering from radio link desynchronization. The method may include determining a first validity rate of a first plurality of PDUs including a length indicator transmitted over the radio link using ciphering based on a hyperframe number. The method may further include determining a second validity rate of a second plurality of PDUs without a length indicator transmitted over the radio link using ciphering based on the hyperframe number. The method may also include detecting desynchronization of the hyperframe number based on the first validity rate and the second validity rate. The method may additionally include initiating a reset procedure to set a new hyperframe number for the radio link based on detecting the desynchronization.

In another aspect, the disclosure provides an apparatus for recovering from radio link desynchronization. The apparatus may include means for determining a first validity rate of a first plurality of PDUs including a length indicator transmitted over the radio link using ciphering based on a hyperframe number. The apparatus may further include means for determining a second validity rate of a second plurality of PDUs without a length indicator transmitted over the radio link using ciphering based on the hyperframe number. The apparatus may also include means for detecting desynchronization of the hyperframe number based on the first validity rate and the second validity rate. The apparatus may additionally include means for initiating a reset procedure to set a new hyperframe number for the radio link based on detecting the desynchronization.

In another aspect, the disclosure provides another apparatus for recovering from radio link desynchronization. The apparatus may include a status component configured to determine a first validity rate of a first plurality of PDUs including a length indicator transmitted over the radio link using ciphering based on a hyperframe number and a second validity rate of a second plurality of PDUs without a length indicator transmitted over the radio link using ciphering based on the hyperframe number. The apparatus may further include a detecting component configured to detect desynchronization of the hyperframe number based on the first validity rate and the second validity rate. The apparatus may also include a reset component configured to initiate a reset procedure to set a new hyperframe number for the radio link based on detecting the desynchronization.

In another aspect, the disclosure provides a computer-readable medium storing computer executable code. The computer-readable medium may include code for determining a first validity rate of a first plurality of PDUs including a length indicator transmitted over the radio link using ciphering based on a hyperframe number. The computer-readable medium may further include code for determining a second validity rate of a second plurality of PDUs without a length indicator transmitted over the radio link using ciphering based on the hyperframe number. The computer-readable medium may also include code for detecting desynchronization of the hyperframe number based on the first validity rate and the second validity rate. The computer-readable medium may additionally include code for initiating a reset procedure to set a new hyperframe number for the radio link based on detecting the desynchronization. The computer-readable medium may be a non-transitory computer-readable medium.

These and other aspects of the invention will become more fully understood upon a review of the detailed description, which follows.

### BRIEF DESCRIPTION OF THE DRAWINGS

FIG. 1 is a schematic diagram of a communication network including an aspect of a network node that may perform hyperframe number desynchronization recovery.

FIG. 2 is a flowchart illustrating a method of hyperframe number desynchronization recovery.

FIG. 3 is a diagram illustrating an aspect of a radio link control component having a transmitting side and a receiving side.

FIG. 4 is a block diagram illustrating an example of a hardware implementation for an apparatus employing a processing system.

FIG. 5 is a block diagram illustrating an example of a telecommunications system.

FIG. 6 is a diagram illustrating an example of an access network.

FIG. 7 is a diagram illustrating an example of a radio protocol architecture for the user and control plane.

FIG. 8 is a block diagram illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In a wireless communication system, a Radio Link Control (RLC) layer may segment a service data unit (SDU) provided by a higher layer into protocol data units (PDU) for transmission. The PDUs may be ciphered using a ciphering key based on a hyperframe number and other parameters, e.g., using an algorithm for performing encryption or decryption. The hyperframe number (HFN) may be used to track PDUs transmitted or received. For example, a radio link may include an uplink HFN and a downlink HFN. The sequence number (SN) assigned to each PDU in each direction may be unique within each hyperframe. Accordingly, a direction, HFN, and SN may uniquely identify each PDU. The ciphering key is synchronized between a transmitting RLC entity and a receiving RLC entity when they use the same hyperframe number and other parameters, but the ciphering key may become desynchronized if the hyperframe number used by each entity becomes desynchronized, e.g., the hyperframe numbers become different. The term radio link desynchronization may refer to a situation in which any parameter shared between a transmitting RLC entity and a receiving RLC entity becomes desynchronized. The term hyperframe desynchronization may refer to a situation in which a hyperframe number shared by RLC entities, in either direction, becomes different at one of the RLC entities. For example, a reconfiguration that changes the hyperframe number may be implemented at one entity, but not the other. When the hyperframe numbers are desynchronized, the RLC entities may be unable to coherently exchange ciphered data. In other words, for example, the transmitting RLC entity and lower layer physical (PHY) connection may be correctly transmitting ciphered data, but the RLC layer of the out-of-synch receiving RLC entity may be unable to decipher the data due to the desynchronization of the hyperframe numbers.

Such a situation may be difficult to detect using existing procedures. Existing RLC recovery procedures may allow a transmitting RLC entity to initiate an RLC RESET when a maximum number of retransmissions is reached, a maximum number of move receive window commands are sent; or a status PDU indicates an erroneous sequence number. A reset procedure, such as but not limited to an RLC RESET, may update a radio link such that the entities on each end use the same information, e.g., hyperframe number. When an RLC RESET is performed, the hyperframe numbers may be resynchronized, but all pending PDUs may be flushed, resulting in data loss. If an RLC RESET is performed due to PDU errors when there is no hyperframe desynchronization, unnecessary packet loss may occur. For example, when PDU errors are due to poor channel conditions, an RLC RESET procedure may exacerbate delays. On the other hand, when the RLC RESET procedure is not performed until reaching a maximum number of errors, additional PDUs may be generated that will be lost during the eventual RESET procedure. Additionally, PDUs that cannot be deciphered correctly may be passed to higher layers, which may be unable to detect or handle corrupted data. The present aspects seek to avoid these results by initiating an RLC RESET to resynchronize hyperframe numbers as soon as possible when a genuine hyperframe desynchronization is detected.

In an aspect, either a transmitting RLC entity or a receiving RLC entity may detect hyperframe desynchronization based on PDU status information. The RLC entity may keep track of the status for each PDU sequence number. A receiving RLC entity may determine the status of a received PDU during a validation process. In acknowledged mode, the receiving RLC entity may transmit the PDU status to the transmitting RLC entity in a STATUS PDU or piggybacked status information.

In an aspect, the RLC entity may detect hyperframe desynchronization based on a first validity rate of PDUs including a length indicator and a second validity rate of PDUs without a length indicator. The first validity rate may be a measure of valid PDUs that include a length indicator as compared to invalid PDUs that include a length indicator, where being invalid is based on whether or not the PDU including the length indicator is deciphered correctly. For example, the first validity rate may be a number, ratio, or percentage of PDUs including a length indicator that were validly received. The second validity rate may be a measure of valid PDUs that do not include a length indicator as compared to invalid PDUs that do not include a length indicator, where being invalid is based on whether or not the PDU without the length indicator is deciphered correctly. For example, the second validity rate may be a number, ratio, or percentage of PDUs without a length indicator that were validly received. In an aspect relating to the first validity rate of PDUs including a length indicator, the length indicator may be ciphered using the ciphering key.

The receiving RLC entity may determine that a PDU is incorrectly received when the deciphered length indicator has an invalid value. For example, the PDU may be invalid if the length indicator indicates that the end of a service data unit (SDU) payload is outside of the PDU. The term “valid range,” when referring to a length indicator value, may mean a value between 0 and the length of the PDU payload, in octets. When the hyperframe numbers are desynchronized, most of the PDUs including a length indicator may be invalid. The receiving RLC entity may transmit a negative acknowledgment (NAK) for the invalid PDUs. Some of the length indicators, however, may still decipher to a value within the valid range. In an aspect relating to the second validity rate of PDUs without a length indicator, the receiving RLC entity may be unable to detect that a PDU without a length indicator is incorrectly ciphered because only higher layer data is ciphered. Therefore, the PDUs without a length indicator may not be negatively acknowledged even if deciphered incorrectly. Accordingly, when the hyperframe numbers are desynchronized, the first validity rate for PDUs including length indicators may drop while the second validity rate for PDUs without length indicators may remain high.

In view of the differences between PDUs including length indicators and PDUs without length indicators, a hyperframe desynchronization may be detected when all the PDUs without length indicators are not negatively acknowledged and most of the PDUs with length indicators are negatively acknowledged. Thus, an RLC entity that detects hyperframe desynchronization based on the validity rates may immediately initiate an RLC RESET procedure to synchronize the hyperframe numbers. Accordingly, an RLC entity according to the present disclosure may be able to detect and recover from a hyperframe desynchronization more quickly than waiting for an RLC RESET according to existing triggers, resulting in less data loss.

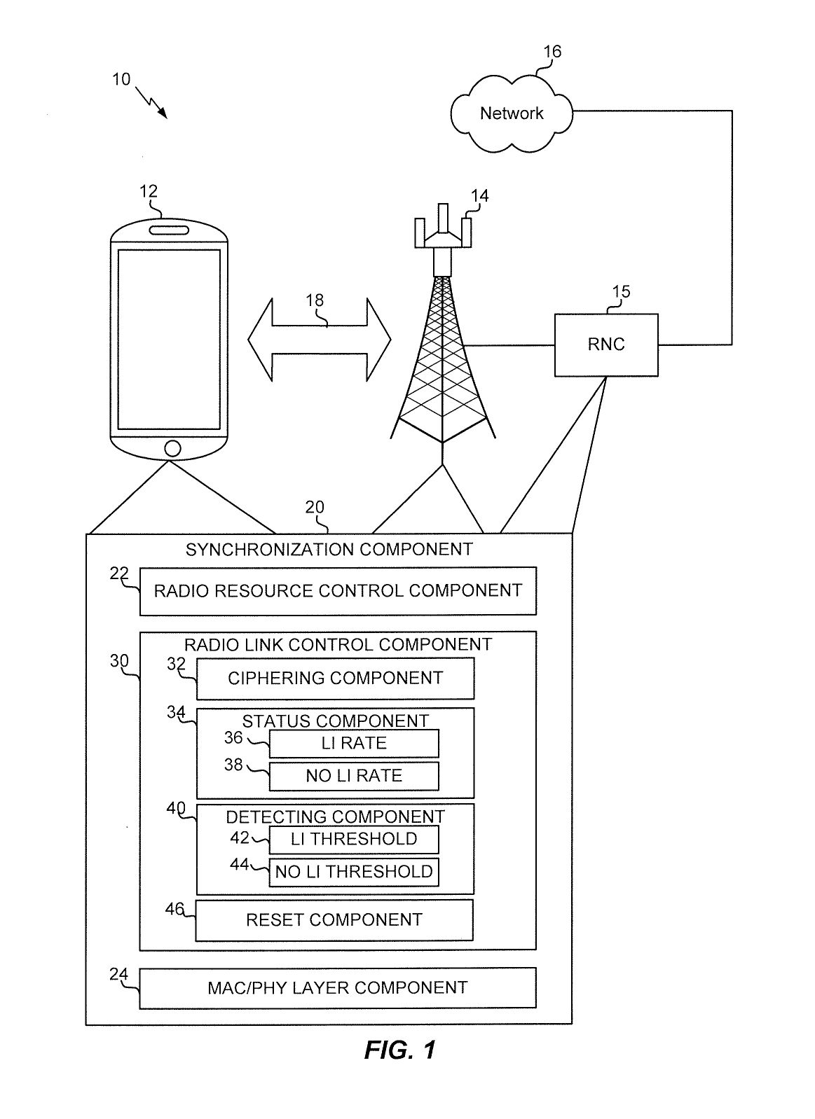

Referring to FIG. 1, in an aspect, a wireless communication system 10 includes at least one UE 12 in communication coverage of at least one network entity 14 (e.g., base station). UE 12 may communicate with network 16 via network entity 14. In some aspects, multiple UEs including UE 12 may be in communication coverage with one or more network entities, including network entity 14. In an example, UE 12 may transmit and/or receive wireless communications to and/or from network entity 14.

In some aspects, UE 12 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, a device for the Internet of Things, or some other suitable terminology. Additionally, network entity 14 may be a macrocell, picocell, femtocell, relay, Node B, mobile Node B, UE (e.g., communicating in peer-to-peer or ad-hoc mode with UE 12), or substantially any type of component that can communicate with UE 12 to provide wireless network access at the UE 12.

In an aspect, the network entity 14 may be a base station such as a Node B in an UTRA network or an eNodeB in an LTE network. The network entity 14 may directly communicate with the network 16, or may communicate via a radio network controller (RNC) 15. In an aspect, the network entity 14 and/or the RNC 15 may include a peer entity for communication with the UE 12. In an example, UE 12 may transmit and/or receive wireless communications 18 to and/or from network entity 14. Such wireless communications 18 may be inherently unreliable to some extent. The wireless communication system 10 may use a radio link control (RLC) protocol to improve reliability of communications. The RLC protocol may segment and/or aggregate higher layer data into protocol data units (PDU) for transmission. The RLC protocol may also provide ciphering to protect the wireless communications 18. The ciphering may be based in part on a hyperframe number of the transmitted PDUs. The present aspects provide for recovery from hyperframe desynchronization between an RLC entity at the UE 12 and a peer RLC entity at the network entity 14 or RNC 15.

Although the term “protocol data unit (PDU)” may refer to the output of any protocol, as used herein, unless modified, the term PDU refers to an RLC layer PDU. Likewise, the term “service data unit (SDU),” unless modified, refers to an RLC SDU. For example, the application layer may generate a transport control protocol (TCP) packet that is passed to the RLC layer as an RLC SDU, which may be referred to simply as an SDU. The RLC layer may generate a plurality of RLC PDUs from the SDU. The RLC PDUs may be referred to simply as PDUs.

According to the present aspects, a network node such as UE 12, network entity 14 and/or RNC 15 may include a synchronization component 20, which may be configured to maintain synchronization between the network node and a peer network node. The synchronization component 20 may be associated with an RLC entity at the network node. In particular, the synchronization component 20 may maintain synchronization of a radio link by detecting and recovering from hyperframe desynchronization. In an aspect, the term “component” as used herein may be one of the parts that make up a system, may be hardware, firmware, and/or software, and may be divided into other components. In an aspect, the synchronization component 20 may include a radio resource control (RRC) component 22, a radio link control (RLC) component 30, and a MAC/PHY component 24

The RRC component 22 may include hardware, software and/or a combination thereof for implementing a RRC protocol. In an aspect, the RRC component 22 may include or be executable by a processor executing firmware or software for implementing a RRC protocol. The RRC protocol may be described in, for example, 3GPP TS 25.331. In particular, the RRC component 22 may be configured to set up a radio link between a UE 12 and a network node such as a network entity 14 or an RNC 15. The RRC component 22 may establish initial parameters for a radio link including ciphering parameters such as a ciphering key and a hyperframe number start value. The RRC component 22 may also update ciphering parameters during operation. In an aspect, the RRC component 22 may update the hyperframe number at only one end of a radio link resulting in hyperframe desynchronization.

The RLC component 30 may include hardware, software and/or a combination thereof for implementing an RLC protocol. In an aspect, the RLC component 30 may include or be executable by a processor executing firmware or software for implementing an RLC protocol. The RLC protocol may be described in, for example, 3GPP TS 25.322. The RLC component 30 may control one or more RLC entities. The RLC component 30 may be configured to manage communications across an over the air (OTA) link. In particular, RLC component 30 may receive an SDU from a higher layer and generate one or more PDUs for transmission on a physical channel. As used herein, transmission by the RLC component 30 may include passing the PDU to a lower layer (e.g., the physical layer) or actual transmission of the PDU on the physical layer to another device. The RLC component 30 may also receive one or more PDUs transmitted by an RLC entity located at the network entity 14 or RNC 15 and assemble the PDUs to form an SDU to pass to the RRC component 22 or another upper layer component. The RLC component 30 may include a memory or buffer for storing received PDUs while waiting for the remaining PDUs of the SDU to arrive. The RLC component 30 may operate in several modes including transparent mode, unacknowledged mode, and acknowledged mode, providing different levels of confidence in delivery. Further, the RLC component 30 may include a ciphering component 32, a status component 34, a detecting component 40, and a reset component 46.

The ciphering component 32 may include hardware, software and/or a combination thereof for ciphering PDU data. In an aspect, the ciphering component 32 may include or be executable by a processor executing firmware or software for implementing ciphering. The ciphering component 32 may, for example, implement a ciphering algorithm such as the ciphering algorithm f8 described in 3GPP TS 33.102. The ciphering algorithm may use a ciphering key, and parameters such as count-C, bearer, direction, and length to generate a keystream block. The ciphering algorithm may be used to cipher a data portion of a PDU, which may include a length indicator if the PDU includes the end of one or more SDUs. The keystream block may be combined with a plaintext block using bit per bit binary addition (exclusive OR) to generate a ciphertext block. The ciphering component 32 may also perform deciphering on the receiving side of the radio link. The receiving side ciphering component 32 may generate the same keystream block and use bit per bit binary addition with the ciphertext block to recover the plaintext block. The Count-C parameter used by the ciphering component 32 may be based on the hyperframe number (HFN) and sequence number of an SDU. In an aspect, the hyperframe number of the transmitting side ciphering component 32 and the receiving side ciphering component 32 may become desynchronized. For example, an RRC procedure may change the HFN.

Desynchronization of the HFN may cause several problems. The receiving side ciphering component 32 may be unable to correctly decipher received PDUs. If the RLC component 30 detects that the received PDU is incorrectly deciphered, the PDU may be discarded and a retransmission requested. Because of the desynchronization, the transmitting side may continue to send undecipherable PDUs until a maximum number of retransmissions is reached and an RLC RESET procedure is initiated. If the RLC component 30 is unable to detect that the received PDU is incorrectly deciphered, the incorrectly deciphered PDU may be passed to higher layers as corrupted data, which may or may not be detected by higher layer protocols.

The status component 34 may include hardware, software and/or a combination thereof for determining the status of PDUs. In an aspect, the status component 34 may include or be executable by a processor executing firmware or software for determining the status of PDUs. In an aspect, the status component 34 may also include a memory for storing information about the PDUs. For example, on the receiving side, the status component 34 may include a receive buffer that stores received PDUs along with a validity indication. A validity indication may indicate whether the received PDU was received correctly. On the transmitting side, the status component 34 may include a retransmission buffer that stores transmitted PDUs along with a status indication. A status indication may indicate whether the transmitted PDU has received an acknowledgment. The PDUs may be tracked according a sequence number, which may be unique within a hyper frame. On the receiving side, the status component 34 may perform validation on received PDUs. The status component 34 may determine an ACK/NAK value for each PDU. For example, the status component 34 may determine whether the header information of a PDU includes valid values. If the PDU includes a length indicator, the status component 34 may determine whether the value of the length indicator is within a valid range. The status component 34 may assign a validity status (valid or invalid) to each PDU. When operating in acknowledged mode, the status component 34 may also provide status information to the transmitting side relating to receipt of a PDU. For example, the status component 34 may transmit STATUS PDUs and/or piggybacked status information indicating whether each PDU is acknowledged (ACK) or negatively acknowledged (NAK). In an aspect, the status information may, for example, indicate only PDUs that are one of ACK or NAK. At the transmitting side, the status component 34 may determine the validity status of transmitted PDUs based on the received status information. The transmitting side status component 34 may determine that a transmitted PDU was validly received unless the transmitted PDU has been negatively acknowledged (NAK). For example, a PDU having a sequence number that was transmitted but has not been included in status information may be considered valid for purposes of determining a validity rate.

The status component 34 may also determine a validity rate of received PDUs. The validity rate may be a number, ratio, or percentage of PDUs that were validly received. A validly received PDU may include a PDU that was correctly received at the receiving side RLC entity. In an aspect, a validly received PDU may be an acknowledged PDU or may be a PDU that has not been negatively acknowledged. In an aspect, the validity rate may be measured for a threshold number (M) of the most recently received PDUs. For example, the status component 34 may determine the validity rate for the M most recently received PDUs. The threshold number M may be a minimum number of PDUs sufficient to detect a pattern. In an aspect, M may have a fixed value (e.g., 10). In another aspect, M may be configurable; for example, the value of M may be configured or scaled based on, for example, the size of the move receive window (MRW) or the sequence number of the last received PDU (e.g., the number of PDUs in the current hyperframe). The status component 34 may separately determine an LI rate 36 and a no LI rate 38. The LI rate 36 may be a number, ratio, or percentage of PDUs including a length indicator that were validly received. The no LI rate 38 may be a number, ratio, or percentage of PDUs without a length indicator that were validly received. For example at the receiving RLC component 30, the status component 34 may determine whether each of the threshold number M most recently received PDUs includes an LI. The most recently received PDUs may be the PDUs in the current hyperframe having the greatest SNs. The M most recently received PDUs may include PDUs having SNs from the last received SN-M up to the last received SN. If a SN in the M most recently received PDUs is missing, the PDU may be considered incorrectly received. The status component 34 may also determine the validity status for each of the M most recently received PDUs. The status component 34 may then calculate the LI rate 36 and the no LI rate 38. For a transmitting RLC component 30, the LI rate 36 and the no LI rate 38 may be based on status information received for each PDU. For example, the M most recently transmitted PDUs may include the last transmitted PDU SN-M to the last transmitted PDU SN. The transmitting side RLC component may not have received status information for each transmitted RLC PDU. Transmitted PDUs that have not received a negative acknowledgment may be considered valid. The status component 34 may therefore determine the validity status for each transmitted PDU. The status component 34 may determine whether each transmitted PDU includes an LI based on the content of the PDUs stored in a retransmission buffer. The status component 34 may then determine the LI rate 36 and the no LI rate 38 for the transmitted PDUs.

The detecting component 40 may include hardware, software and/or a combination thereof for detecting desynchronization of the hyperframe number. In an aspect, the detecting component 40 may include or be executable by a processor executing firmware or software for detecting desynchronization of the hyperframe number based on the LI rate 36 and the no LI rate 38. For instance, the detecting component 40 may set an LI threshold 42 for the LI rate 36 and a no LI threshold 44 for the no LI rate 38 for use in determining hyperframe desynchronization. The LI threshold 42 for the LI rate 36 may be relatively lower than the no LI threshold 44 for the no LI rate 38. For example, the no LI threshold 44 may be at or close to 100% because the status component 34 may not be able to detect errors in ciphering the data of the PDU. Accordingly, any invalid PDUs without a length indicator may be due to lower layer (e.g. PHY layer or channel condition) errors rather than HFN desynchronization. The detecting component 40 may avoid detecting a hyperframe desynchronization when the channel conditions are poor by setting a high no LI threshold 44. In an aspect, the no LI rate 38 being greater than or equal to the no LI threshold 44 may indicate that that all PDUs of the most recent PDUs without an LI were not negatively acknowledged. The LI threshold 42, however, may be lower than the no LI threshold 44 because the status component 34 may be able to detect errors in deciphering of the LI. For example, an incorrectly deciphered LI may fall outside of a valid range. The LI threshold 42 may be configured based on the configured PDU size. A larger PDU size may be more likely to include an erroneously deciphered LI value, so the LI threshold 42 may be higher. For example, the LI threshold 42 may be 50%, but may be up to 80% for a large PDU size and as low as 30% for a small PDU size. The detecting component 40 may detect desynchronization of the hyperframe number when the LI rate 36 is less than the LI threshold 42 and the no LI rate 38 is greater than the no LI threshold 44. This condition may indicate that errors are due to desynchronization rather than PHY layer errors or channel conditions.

The reset component 46 may include hardware, software and/or a combination thereof for performing a reset procedure. In an aspect, the reset component 46 may include or be executable by a processor executing firmware or software for performing a reset procedure. The reset component 46 at either the transmitting side or the receiving side may initiate the reset procedure based on detection of hyperframe desynchronization. The reset component 46 may perform a reset procedure as described in, for example, 3GPP TS 25.322. The reset procedure may include sending a reset PDU and receiving a reset ACK. The reset PDU may include a HFN index field set to the currently highest used HFN and a reset PDU sequence number. The reset component 46 on the side receiving the reset PDU may set the HFN to the HFN index field and discard any pending PDUs. Communications may then be resumed using the new HFN.

The MAC/PHY component 24 may be configured to perform lower layer processing of RLC layer PDUs. In an aspect, for example, the MAC/PHY component 24 may include or be executable by a processor executing firmware or software for performing lower layer processing. The MAC/PHY component 24 may also include a transmitter and a receiver for sending and receiving radio signals. For example, the MAC/PHY component 24 may include a radio frequency (RF) transmitter and receiver, or transceiver or protocol layer entities associated therewith. The MAC/PHY component 24 may receive RLC PDUs from RLC component 30 and transmit the PDUs as radio signals. On the receiving side, the MAC/PHY component 24 may receive radio signals and provide PDUs to the RLC component 30.

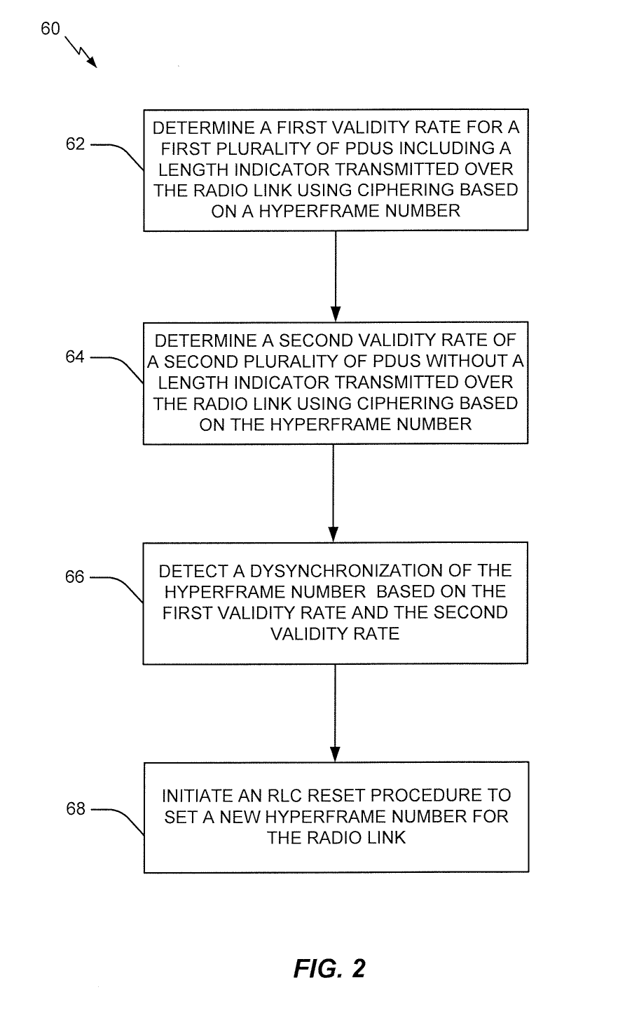

Referring to FIG. 2, in an operational aspect, a UE such as UE 12 (FIG. 1), a network entity such as network entity 14 (FIG. 1) or an RNC such as RNC 15 FIG. 1 may perform one aspect of a method 60 for hyperframe desynchronization recovery. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, at block 62, the method 60 may include determining a first validity rate of a first plurality of protocol data units (PDUs) including a length indicator transmitted over the radio link using ciphering based on a hyperframe number. In an aspect, for example, the status component 34 may determine the validity rate for the first plurality of PDUs including a length indicator transmitted over the radio link using ciphering based on the hyperframe number. On a receiving side, the status component 34 may determine the LI rate 36 based on a validation status of received PDUs including an LI field. On the transmitting side, the status component 34 may determine the LI rate 36 based on status information received for transmitted PDUs including an LI field. The status component 34 may assume that any PDU that has not received a negative acknowledgement was correctly received.

In an aspect, at block 64, the method 60 may include determining a second validity rate of a second plurality of PDUs without a length indicator transmitted over the radio link using ciphering based on the hyperframe number. In an aspect, for example, the status component 34 may determine the validity rate for the second plurality of PDUs without a length indicator transmitted over the radio link using ciphering based on the hyperframe number. On a receiving side, the status component 34 may determine the no LI rate 38 based on a validation status of each received PDU without an LI field. On the transmitting side, the status component 34 may determine the no LI rate 38 based on status information received for transmitted PDUs without an LI field. The status component 34 may assume that any PDU that has not received a negative acknowledgement was correctly received.

At block 66, the method 60 may include detecting desynchronization of the hyperframe number based on the first validity rate and the second validity rate. In an aspect, for example, the detecting component 40 may detect desynchronization of the hyperframe number based on the first validity rate and the second validity rate. In an aspect, the detecting component 40 may detect a desynchronization when the first validity rate is less than a first threshold and the second validity rate is greater than a second threshold. The first threshold may be lower than the second threshold. The first threshold may be based on a configured PDU size. The second threshold may be close to 100%. For example, the second threshold may be 90%, 95%, or 99%. The second threshold may require all received PDUs without LI to be correctly received.

At block 68, the method 60 may include initiating a reset procedure to set a new hyperframe number for the radio link. In an aspect, the reset component 46 may initiate the reset procedure to set a new hyperframe number for the radio link. For example, the reset component 46 may transmit a reset PDU including the new hyperframe number.

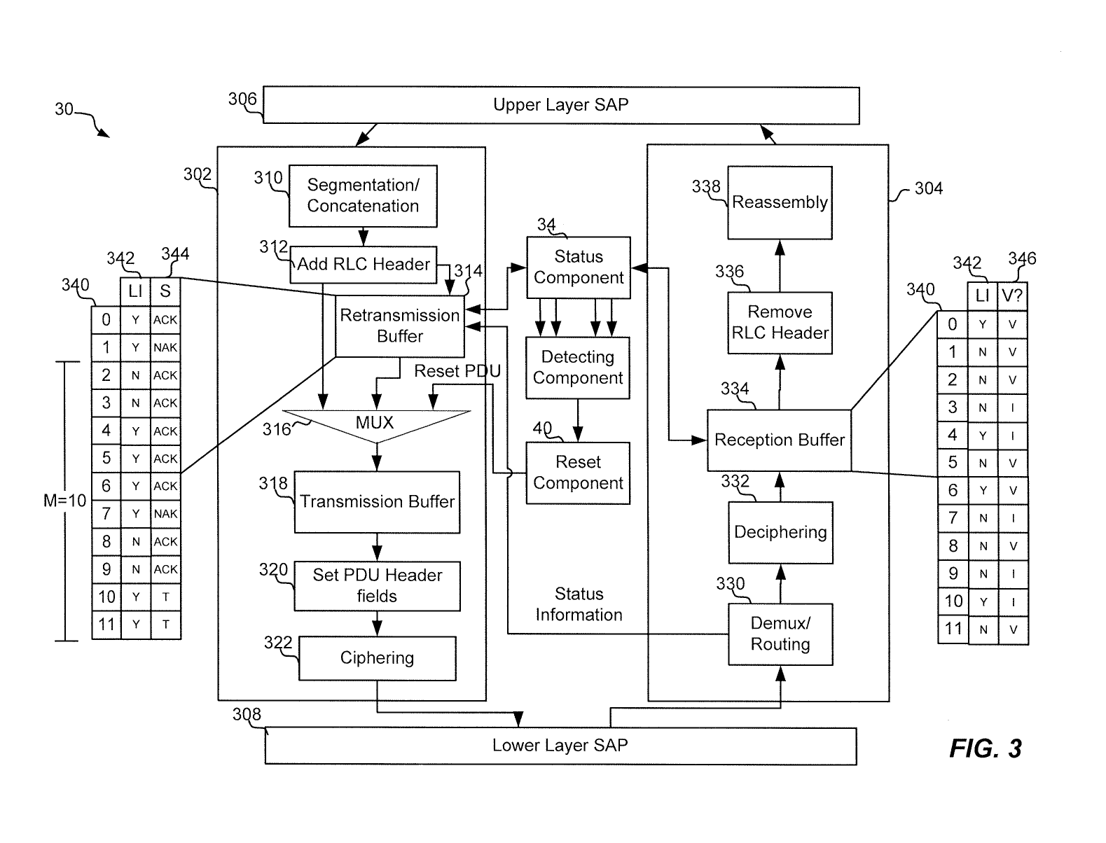

FIG. 3 is a block diagram illustrating an example of a RLC component 30 having a transmitting side 302 and a receiving side 304. The RLC component 30 may communicate with a peer radio link control component located across a radio link. For example, the RLC component 30 may be located in a UE 12 (FIG. 1) and communicate with a peer radio link component located in the RNC 15 (FIG. 1), which may also have a transmitting side and a receiving side.

The RLC component 30 may communicate with upper layers via an upper layer service access point (SAP) 306. For example, the transmitting side 302 may receive SDUs from upper layers via the upper layer SAP 306, and the receiving side 304 may send SDUs to the upper layers via the upper layer SAP 306. The RLC component 30 may communicate with lower layers via the lower layer SAP 308. For example, the transmitting side may send PDUs to the lower layers via the lower layer SAP 308, and the receiving side 304 may receive PDUs from the lower layers via the lower layer SAP 308. At the transmitting side, at block 310, the RLC component 30 may perform segmentation and/or concatenation on the received SDUs based on the PDU size. For example, the RLC component 30 may concatenate multiple SDUs that are smaller than the PDU size and add a length indicator to indicate where each SDU ends. At block 312, the RLC component 30 may add an RLC header to complete the PDU. Copies of the PDU may then be sent to both the retransmission buffer 314 and the multiplexer 316. The copy sent to the retransmission buffer 314 may be used to track the status of the PDU and for retransmission if necessary. The copy sent to the multiplexer 316 may be multiplexed with retransmitted PDUs and reset PDUs for transmission. In block 318 the PDUs may be stored in a transmission buffer. In block 320, the RLC component 30 may set PDU header fields such as the polling bit and piggybacked status information. In block 322, the ciphering component 32 may cipher the payload portion of the PDU including any length indicators.

At the receiving side, at block 330, the RLC component 30 may demultiplex received PDUs. For example, the RLC component 30 may send status PDUs to the retransmission buffer 314 of the receiving side. At block 332, the ciphering component 32 may decipher the payload portion of the PDU including any length indicators and send the deciphered PDUs to the reception buffer 334. The reception buffer 334 may store the received PDUs while waiting for additional PDUs, which may be delayed, for example, due to lower layer errors or retransmissions. In block 336, the RLC component 30 may remove the RLC header from the received PDUs. In block 338, the original SDUs may be reassembled.

In an aspect, the status component 34 may determine validity rates for SDUs based on information in the retransmission buffer 314 and the reception buffer 334. In an aspect, the status component 34 may determine validity rates for the transmitting side 302 and/or the receiving side 304.

On the transmitting side 302, the retransmission buffer may store each SDU that has been transmitted. Each SDU may be identified by a sequence number 340 and a HFN. In an aspect, the validity rate may be determined for PDUs having the same HFN to determine whether the HFN is desynchronized. The retransmission buffer 314 may also store an indicator 342 of whether the SDU included a length indicator. Alternatively, the status component 34 may determine whether the SDU includes a length indicator based on the content of the SDU in the retransmission buffer 314. The retransmission buffer 314 may also store a status indicator 344 for the current status of the SDU. For example, the status indicator 344 may indicate that the SDU has been acknowledged (ACK), negatively acknowledged (NAK), or transmitted and awaiting status information (T). The status component 34 may determine the LI rate 36 and the no LI rate 38 based on the M most recent PDUs. For example, if M=10, SDUs with SN 2-11 may be used. In the example, of these PDUs, 6 may have included length indicators, with 3 of the 6 having received an ACK, 1 of the 6 receiving a NAK, and two not yet receiving status information. The two PDUs having no status information may be considered valid. Accordingly, the LI rate 36 may be 5/6 or approximately 83%. For the PDUs with no LI, there may be 4 PDUs, each of which has received an ACK. Accordingly, the no LI rate 38 may be 4/4 or 100% for this example. In this case, the detecting component 40 may determine that the LI rate 36 of %83 is greater than the LI threshold 42 (e.g. 80%). Accordingly, the detecting component 40 may determine that no HFN desynchronization has occurred. However, if the last two PDUs were to receive a NAK, the LI rate 36 may drop to 3/6 or 50%, and the detecting component 40 may determine that an HFN desynchronization has occurred because a large percent of PDUs including length indicators are being reported as invalid while no problems are reported for PDUs without LI.

On the receiving side 304, the reception buffer 334 may similarly store received PDUs according to SN 340 and store an indicator 342 indicating whether the PDU included a length indicator. Instead of a status indicator 344, the reception buffer 334 may store a validity indicator 346 or the status component 34 may determine the validity for each PDU. The validity indicator 346 may indicate valid (V) or invalid (I). The validity may be used to determine the status information provided to the transmission side for inclusion in a status PDU or piggybacked status information. The reception buffer 334 may have a validity indicator 346 for each received PDU because the validity can be determined when the PDU is received. In the example shown in FIG. 3, when M=10, there may be 3 PDUs including length indicators, of which 1 is valid and 2 are invalid. Accordingly, the LI rate 36 for the receiving side 304 may be 1/3 or approximately 33%. There may be 7 PDUs with no length indicator, of which 4 are valid and 3 are invalid. Accordingly, the no LI rate 36 may be 4/7 or approximately 57%. In this case, although the LI rate 36 may be less than the LI threshold 42, the detecting component 40 may determine that the low no LI rate 38 may indicate lower layer failures rather than an HFN desynchronization.

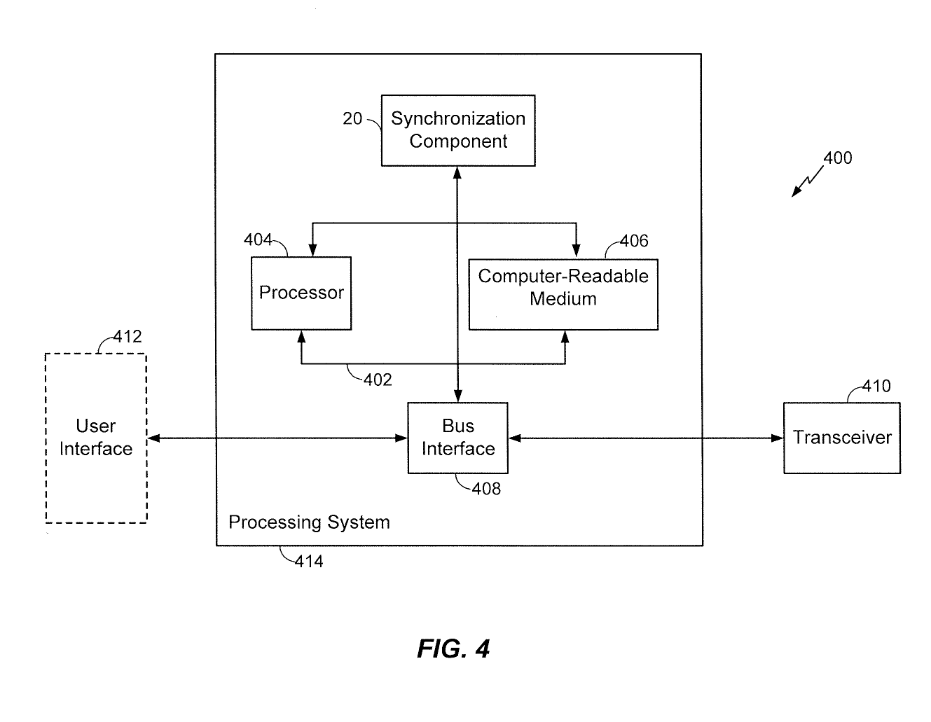

FIG. 4 is a block diagram illustrating an example of a hardware implementation for an apparatus 400 employing a processing system 414. The processing system 414 may include a synchronization component 20 for recovering from hyperframe desynchronization. In this example, the processing system 414 may be implemented with a bus architecture, represented generally by the bus 402. The bus 402 may include any number of interconnecting buses and bridges depending on the specific application of the processing system 414 and the overall design constraints. The bus 402 links together various circuits including one or more processors, represented generally by the processor 404, and computer-readable media, represented generally by the computer-readable medium 406. The bus 402 may also link various other circuits such as timing sources, peripherals, voltage regulators, and power management circuits, which are well known in the art, and therefore, will not be described any further. A bus interface 408 provides an interface between the bus 402 and a transceiver 410. The transceiver 410 provides a means for communicating with various other apparatus over a transmission medium. Depending upon the nature of the apparatus, a user interface 412 (e.g., keypad, display, speaker, microphone, joystick) may also be provided.

The processor 404 is responsible for managing the bus 402 and general processing, including the execution of software stored on the computer-readable medium 406. The software, when executed by the processor 404, causes the processing system 414 to perform the various functions described infra for any particular apparatus. The computer-readable medium 406 may also be used for storing data that is manipulated by the processor 404 when executing software. In an aspect, for example, at least a portion of the functions, operations, and/or methods performed by the synchronization component 20 may be implemented by the processor 404 in cooperation with the computer-readable medium 406.

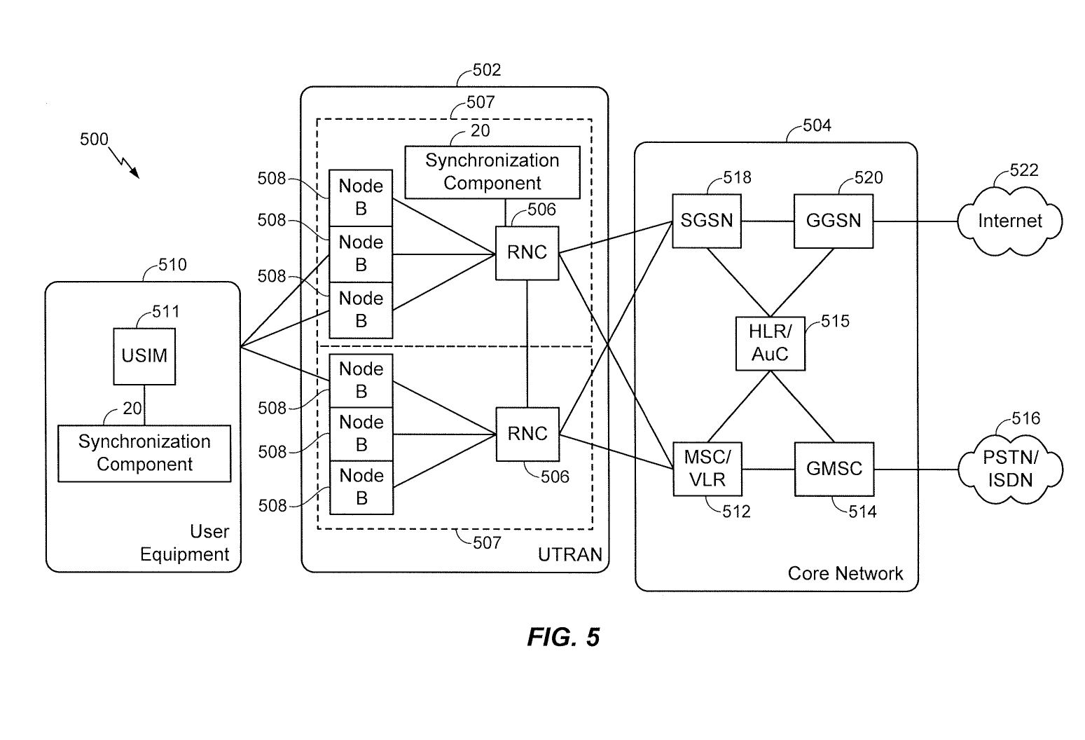

The various concepts presented throughout this disclosure may be implemented across a broad variety of telecommunication systems, network architectures, and communication standards. By way of example and without limitation, the aspects of the present disclosure illustrated in FIG. 5 are presented with reference to a UMTS system 500 employing a W-CDMA air interface. A UMTS network includes three interacting domains: a Core Network (CN) 504, a UMTS Terrestrial Radio Access Network (UTRAN) 502, and User Equipment (UE) 510. The UE 510 may be an example of the UE 12 (FIG. 1) and include a synchronization component 20 for recovering from hyperframe desynchronization. In this example, the UTRAN 502 provides various wireless services including telephony, video, data, messaging, broadcasts, and/or other services. The UTRAN 502 may include a plurality of Radio Network Subsystems (RNSs) such as an RNS 507, each controlled by a respective Radio Network Controller (RNC) such as an RNC 506. The RNC 506 may also include a synchronization component 20 for recovering from hyperframe desynchronization. Here, the UTRAN 502 may include any number of RNCs 506 and RNSs 507 in addition to the RNCs 506 and RNSs 507 illustrated herein. The RNC 506 is an apparatus responsible for, among other things, assigning, reconfiguring and releasing radio resources within the RNS 507. The RNC 506 may be interconnected to other RNCs (not shown) in the UTRAN 502 through various types of interfaces such as a direct physical connection, a virtual network, or the like, using any suitable transport network.

Communication between a UE 510 and a Node B 508 may be considered as including a physical (PHY) layer and a medium access control (MAC) layer. Further, communication between a UE 510 and an RNC 506 by way of a respective Node B 508 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331. The synchronization component 20 may operate at layer 2.

The geographic region covered by the RNS 507 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 508 are shown in each RNS 507; however, the RNSs 507 may include any number of wireless Node Bs. The Node Bs 508 provide wireless access points to a CN 504 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 510 may further include a universal subscriber identity module (USIM) 511, which contains a user's subscription information to a network. For illustrative purposes, one UE 510 is shown in communication with a number of the Node Bs 508. The DL, also called the forward link, refers to the communication link from a Node B 508 to a UE 510, and the UL, also called the reverse link, refers to the communication link from a UE 510 to a Node B 508.

The CN 504 interfaces with one or more access networks, such as the UTRAN 502. As shown, the CN 504 is a GSM core network. However, as those skilled in the art will recognize, the various concepts presented throughout this disclosure may be implemented in a RAN, or other suitable access network, to provide UEs with access to types of CNs other than GSM networks.

The CN 504 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 504 supports circuit-switched services with a MSC 512 and a GMSC 514. In some applications, the GMSC 514 may be referred to as a media gateway (MGW). One or more RNCs, such as the RNC 506, may be connected to the MSC 512. The MSC 512 is an apparatus that controls call setup, call routing, and UE mobility functions. The MSC 512 also includes a VLR that contains subscriber-related information for the duration that a UE is in the coverage area of the MSC 512. The GMSC 514 provides a gateway through the MSC 512 for the UE to access a circuit-switched network 516. The GMSC 514 includes a home location register (HLR) 515 containing subscriber data, such as the data reflecting the details of the services to which a particular user has subscribed. The HLR is also associated with an authentication center (AuC) that contains subscriber-specific authentication data. When a call is received for a particular UE, the GMSC 514 queries the HLR 515 to determine the UE's location and forwards the call to the particular MSC serving that location.

The CN 504 also supports packet-data services with a serving GPRS support node (SGSN) 518 and a gateway GPRS support node (GGSN) 520. GPRS, which stands for General Packet Radio Service, is designed to provide packet-data services at speeds higher than those available with standard circuit-switched data services. The GGSN 520 provides a connection for the UTRAN 502 to a packet-based network 522. The packet-based network 522 may be the Internet, a private data network, or some other suitable packet-based network. The primary function of the GGSN 520 is to provide the UEs 510 with packet-based network connectivity. Data packets may be transferred between the GGSN 520 and the UEs 510 through the SGSN 518, which performs primarily the same functions in the packet-based domain as the MSC 512 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 508 and a UE 510. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 510 provides feedback to the node B 508 over the HS-DPCCH to indicate whether it correctly decoded a packet on the downlink.

HS-DPCCH further includes feedback signaling from the UE 510 to assist the node B 508 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 508 and/or the UE 510 may have multiple antennas supporting MIMO technology. The use of MIMO technology enables the node B 508 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 510 to increase the data rate or to multiple UEs 510 to increase the overall system capacity. This is achieved by spatially precoding each data stream and then transmitting each spatially precoded stream through a different transmit antenna on the downlink. The spatially precoded data streams arrive at the UE(s) 510 with different spatial signatures, which enables each of the UE(s) 510 to recover the one or more the data streams destined for that UE 510. On the uplink, each UE 510 may transmit one or more spatially precoded data streams, which enables the node B 508 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

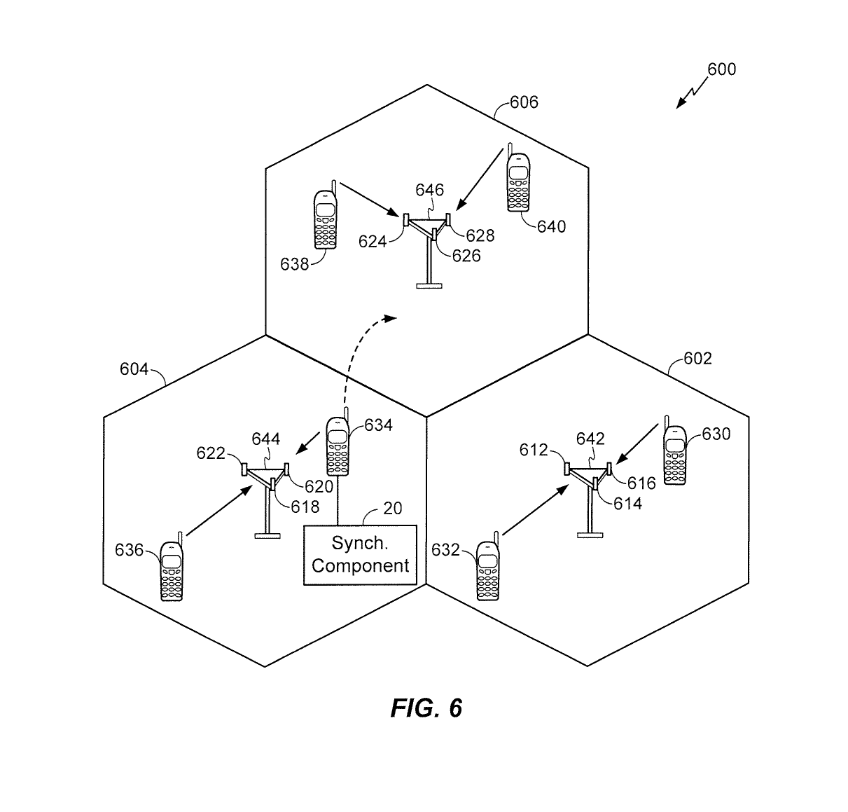

Referring to FIG. 6, an access network 600 in a UTRAN architecture is illustrated. The access network 600 may provide communications for UEs 630, 632, 634, 636, 638, 640, each of which may be an example of the UE 12 (FIG. 1) and include a synchronization component 20. The multiple access wireless communication system includes multiple cellular regions (cells), including cells 602, 604, and 606, each of which may include one or more sectors. The multiple sectors can be formed by groups of antennas with each antenna responsible for communication with UEs in a portion of the cell. For example, in cell 602, antenna groups 612, 614, and 616 may each correspond to a different sector. In cell 604, antenna groups 618, 620, and 622 each correspond to a different sector. In cell 606, antenna groups 624, 626, and 628 each correspond to a different sector. The cells 602, 604 and 606 may include several wireless communication devices, e.g., UEs, which may be in communication with one or more sectors of each cell 602, 604 or 606. For example, UEs 630 and 632 may be in communication with Node B 642, UEs 634 and 636 may be in communication with Node B 644, and UEs 638 and 640 can be in communication with Node B 646. Here, each Node B 642, 644, 646 is configured to provide an access point to a CN 504 (see FIG. 5) for all the UEs 630, 632, 634, 636, 638, 640 in the respective cells 602, 604, and 606.

As the UE 634 moves from the illustrated location in cell 604 into cell 606, a serving cell change (SCC) or handover may occur in which communication with the UE 634 transitions from the cell 604, which may be referred to as the source cell, to cell 606, which may be referred to as the target cell. Management of the handover procedure may take place at the UE 634, at the Node Bs corresponding to the respective cells, at a radio network controller 506 (see FIG. 5), or at another suitable node in the wireless network. For example, during a call with the source cell 604, or at any other time, the UE 634 may monitor various parameters of the source cell 604 as well as various parameters of neighboring cells such as cells 606 and 602. Further, depending on the quality of these parameters, the UE 634 may maintain communication with one or more of the neighboring cells. During this time, the UE 634 may maintain an Active Set, that is, a list of cells that the UE 634 is simultaneously connected to (i.e., the UTRA cells that are currently assigning a downlink dedicated physical channel DPCH or fractional downlink dedicated physical channel F-DPCH to the UE 634 may constitute the Active Set).

The modulation and multiple access scheme employed by the access network 600 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

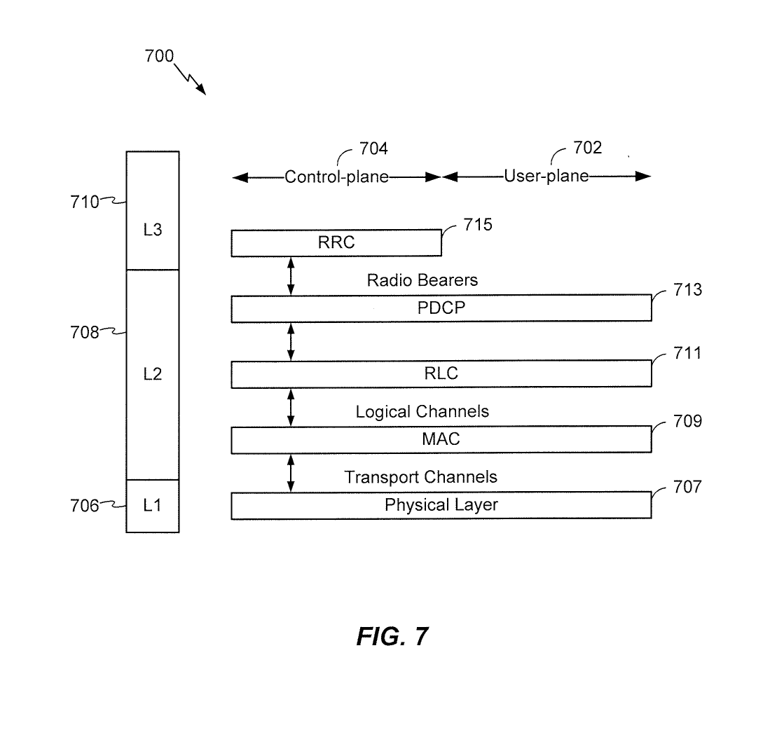

The radio protocol architecture may take on various forms depending on the particular application. An example for an HSPA system will be presented below with reference to FIG. 7.

Referring to FIG. 7, an example radio protocol architecture 700 relates to the user plane 702 and the control plane 704 of a UE or node B/base station. For example, architecture 700 may be included in a UE such as UE 12 (FIG. 1) having a synchronization component 20 as well as included in a network entity 14 or RNC 15 (FIG. 1) having a synchronization component. The radio protocol architecture 700 for the UE and node B is shown with three layers: Layer 1 706, Layer 2 708, and Layer 3 710. Layer 1 706 is the lowest layer and implements various physical layer signal processing functions. As such, Layer 1 706 includes the physical layer 707. Layer 2 (L2 layer) 708 is above the physical layer 707 and is responsible for the link between the UE and node B over the physical layer 707. Layer 3 (L3 layer) 710 includes a radio resource control (RRC) sublayer 715. The RRC sublayer 715 handles the control plane signaling of Layer 3 between the UE and the UTRAN. The control plane signaling may include RRC reconfiguration messages, which the UE 12 may validate based on SDU lifetime.

In the user plane, the L2 layer 708 includes a media access control (MAC) sublayer 709, a radio link control (RLC) sublayer 711, and a packet data convergence protocol (PDCP) 713 sublayer, which are terminated at the node B on the network side. Although not shown, the UE may have several upper layers above the L2 layer 708 including a network layer (e.g., IP layer) that is terminated at a PDN gateway on the network side, and an application layer that is terminated at the other end of the connection (e.g., far end UE, server, etc.).

The PDCP sublayer 713 provides multiplexing between different radio bearers and logical channels. The PDCP sublayer 713 also provides header compression for upper layer data packets to reduce radio transmission overhead, security by ciphering the data packets, and handover support for UEs between node Bs. The RLC sublayer 711 provides segmentation and reassembly of upper layer data packets, retransmission of lost data packets, and reordering of data packets to compensate for out-of-order reception due to hybrid automatic repeat request (HARQ). The RLC sublayer 711 may also provide measurements of receiving delay between receipt of RLC data packets or PDU. The MAC sublayer 709 provides multiplexing between logical and transport channels. The MAC sublayer 709 is also responsible for allocating the various radio resources (e.g., resource blocks) in one cell among the UEs. The MAC sublayer 709 is also responsible for HARQ operations.

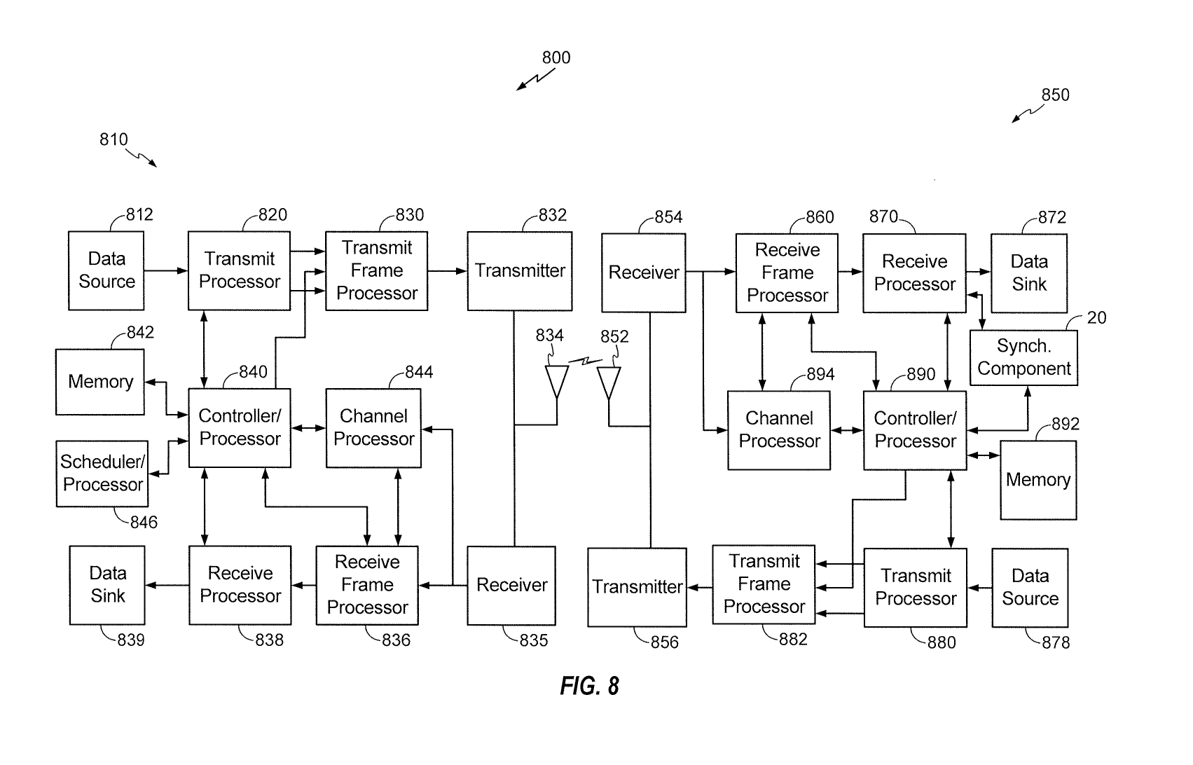

FIG. 8 is a block diagram of a Node B 810 in communication with a UE 850, where the Node B 810 may be the Node B 508 in FIG. 5 or the network entity 14 in FIG. 1, and the UE 850 may be the UE 510 in FIG. 5 or the UE 12 in FIG. 1. The UE 850 may include a synchronization component 20 for recovering from hyperframe number desynchronization. Although the synchronization component 20 is shown in a particular configuration in FIG. 8, the disclosure need not be so limited and the synchronization component 20 may be implemented in a different configuration and/or as part of one or more of the various components of UE 850. In the downlink communication, a transmit processor 820 may receive data from a data source 812 and control signals from a controller/processor 840. The transmit processor 820 provides various signal processing functions for the data and control signals, as well as reference signals (e.g., pilot signals). For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 844 may be used by a controller/processor 840 to determine the coding, modulation, spreading, and/or scrambling schemes for the transmit processor 820. These channel estimates may be derived from a reference signal transmitted by the UE 850 or from feedback from the UE 850. The symbols generated by the transmit processor 820 are provided to a transmit frame processor 830 to create a frame structure. The transmit frame processor 830 creates this frame structure by multiplexing the symbols with information from the controller/processor 840, resulting in a series of frames. The frames are then provided to a transmitter 832, which provides various signal conditioning functions including amplifying, filtering, and modulating the frames onto a carrier for downlink transmission over the wireless medium through antenna 834. The antenna 834 may include one or more antennas, for example, including beam steering bidirectional adaptive antenna arrays or other similar beam technologies.

At the UE 850, a receiver 854 receives the downlink transmission through an antenna 852 and processes the transmission to recover the information modulated onto the carrier. The information recovered by the receiver 854 is provided to a receive frame processor 860, which parses each frame, and provides information from the frames to a channel processor 894 and the data, control, and reference signals to a receive processor 870. The receive processor 870 then performs the inverse of the processing performed by the transmit processor 820 in the Node B 810. More specifically, the receive processor 870 descrambles and despreads the symbols, and then determines the most likely signal constellation points transmitted by the Node B 810 based on the modulation scheme. These soft decisions may be based on channel estimates computed by the channel processor 894. The soft decisions are then decoded and deinterleaved to recover the data, control, and reference signals. The CRC codes are then checked to determine whether the frames were successfully decoded. The data carried by the successfully decoded frames will then be provided to a data sink 872, which represents applications running in the UE 850 and/or various user interfaces (e.g., display). The synchronization component 20 may receive the decoded frames from receive processor 870 or data sink 872 for determining the validity rate of received PDUs. Control signals carried by successfully decoded frames will be provided to a controller/processor 890. When frames are unsuccessfully decoded by the receive processor 870, the controller/processor 890 may also use an acknowledgement (ACK) and/or negative acknowledgement (NACK) protocol to support retransmission requests for those frames.

In the uplink, data from a data source 878 and control signals from the controller/processor 890 are provided to a transmit processor 880. The data source 878 may represent applications running in the UE 850 and various user interfaces (e.g., keyboard). Similar to the functionality described in connection with the downlink transmission by the Node B 810, the transmit processor 880 provides various signal processing functions including CRC codes, coding and interleaving to facilitate FEC, mapping to signal constellations, spreading with OVSFs, and scrambling to produce a series of symbols. Channel estimates, derived by the channel processor 894 from a reference signal transmitted by the Node B 810 or from feedback contained in the midamble transmitted by the Node B 810, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with information from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the Node B 810 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides information from the frames to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 839 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the Node B 810 and the UE 850, respectively. For example, the controller/processors 840 and 890 may provide various functions including timing, peripheral interfaces, voltage regulation, power management, and other control functions. The computer readable media of memories 842 and 892 may store data and software for the Node B 810 and the UE 850, respectively. A scheduler/processor 846 at the Node B 810 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. A method for recovering from radio link desynchronization, comprising:
determining a first validity rate of a first plurality of protocol data units (PDUs) including a length indicator transmitted over the radio link using ciphering based on a hyperframe number;
determining a second validity rate of a second plurality of PDUs without a length indicator transmitted over the radio link using ciphering based on the hyperframe number;
detecting a desynchronization of the hyperframe number based on the first validity rate and the second validity rate; and
initiating a reset procedure to set a new hyperframe number for the radio link based on detecting the desynchronization.

2. The method of claim 1, wherein detecting desynchronization of the hyperframe number includes:
determining that the first validity rate is less than a first threshold; and
determining that the second validity rate is greater than or equal to a second threshold.

3. The method of claim 2, wherein the first threshold is less than the second threshold.

4. The method of claim 2, wherein the first threshold is based on a configured PDU size.

5. The method of claim 2, wherein the second validity rate being greater than or equal to the second thresholdindicates that all PDUs of the second plurality of PDUs were not negatively acknowledged.

6. The method of claim 1, wherein determining the first validity rate includes determining whether a threshold number of most recently received PDUs of the first plurality of PDUs were correctly received.

7. The method of claim 1, wherein determining the first validity rate includes determining whether each of the first plurality of PDUs includes a length indicator with a value within a valid range.

8. The method of claim 1, wherein determining the first validity rate includes determining whether a threshold number of most recently transmitted PDUs of the first plurality of PDUs have received a negative acknowledgement.

9. The method of claim 1, wherein determining the second validity rate includes determining whether a threshold number of most recently received PDUs of the second plurality of PDUs were correctly received.

10. The method of claim 1, wherein determining the second validity rate includes determining whether a threshold number of most recently transmitted PDUs of the second plurality of PDUs have received a negative acknowledgement.

11. The method of claim 1, wherein the first validity rate and the second validity rate are based on status information of a STATUS PDU received from a receiving RLC entity or piggybacked status information received from the receiving RLC entity.

12. An apparatus for recovering from radio link desynchronization, comprising:
a status component configured to determine a first validity rate of a first plurality of protocol data units (PDUs) including a length indicator transmitted over the radio link using ciphering based on a hyperframe number and a second validity rate of a second plurality of PDUs without a length indicator transmitted over the radio link using ciphering based on the hyperframe number;
a detecting component configured to detect a desynchronization of the hyperframe number based on the first validity rate and the second validity rate; and
a reset component configured to initiate a reset procedure to set a new hyperframe number for the radio link based on detecting the desynchronization.

13. The apparatus of claim 12, wherein the detecting component is configured to detect the desynchronization by:
determining that the first validity rate is less than a first threshold; and
determining that the second validity rate is greater than or equal to a second threshold.

14. The apparatus of claim 13, wherein the first threshold is less than the second threshold.

15. The apparatus of claim 13, wherein the first threshold is based on a configured PDU size.

16. The apparatus of claim 13, wherein the second validity rate being greater than or equal to the second thresholdindicates that all PDUs of the second plurality of PDUs were not negatively acknowledged.

17. The apparatus of claim 12, further comprising a receive buffer configured to store at least a threshold number of most recently received PDUs, wherein the status component is configured to determine the first validity rate and the second validity rate by determining whether the threshold number of most recently received PDUs were correctly received.

18. The apparatus of claim 12, wherein the status component is configured to determine the first validity rate by determining whether each of a number of most recently received PDUs of the first plurality of PDUs include a length indicator with a value within a valid range.

19. The apparatus of claim 12, further comprising a retransmission buffer configured to store at least a threshold number of most recently transmitted PDUs, wherein the status component is configured to determine the first validity rate and the second validity rate by determining whether each of the threshold number of most recently transmitted PDUs have not received a negative acknowledgement.

20. The apparatus of claim 12, wherein the first validity rate and the second validity rate are based on status information of a STATUS PDU received from a receiving RLC entity or piggybacked status information received from the receiving RLC entity.

21. An apparatus for recovering from radio link desynchronization, comprising:
means for determining a first validity rate of a first plurality of protocol data units (PDUs) including a length indicator transmitted over the radio link using ciphering based on a hyperframe number;
means for determining a second validity rate of a second plurality of PDUs without a length indicator transmitted over the radio link using ciphering based on the hyperframe number;
means for detecting a desynchronization of the hyperframe number based on the first validity rate and the second validity rate; and
means for initiating a reset procedure to set a new hyperframe number for the radio link based on detecting the desynchronization.

22. The apparatus of claim 21, wherein the means for detecting comprises:
means for determining that the first validity rate is less than a first threshold; and
means for determining that the second validity rate is greater than or equal to a second threshold.

23. The apparatus of claim 22, wherein the first threshold is less than the second threshold.

24. The apparatus of claim 21, further comprising means for storing the first plurality of PDUs, the second plurality of PDUs, and an indicator of a status for each PDU.

25. The apparatus of claim 21, wherein the means for determining a first validity rate comprises means for determining whether each of the first plurality of PDUs includes a length indicator with a value within a valid range.

26. A computer-readable medium storing computer executable code for detecting radio link desynchronization, comprising:
code for determining a first validity rate of a first plurality of protocol data units (PDUs) including a length indicator transmitted over the radio link using ciphering based on a hyperframe number;
code for determining a second validity rate of a second plurality of PDUs without a length indicator transmitted over the radio link using ciphering based on the hyperframe number;
code for detecting a desynchronization of the hyperframe number based on the first validity rate and the second validity rate; and
code for initiating a reset procedure to set a new hyperframe number for the radio link based on detecting the desynchronization.

27. The computer-readable medium of claim 26, wherein the code for detecting desynchronization of the hyperframe number includes:
code for determining that the first validity rate is less than a first threshold; and
code for determining that the second validity rate is greater than or equal to a second threshold.

28. The computer-readable medium of claim 27, wherein the first threshold is less than the second threshold.

29. The computer-readable medium of claim 26, wherein the code for determining the first validity rate includes code for determining whether each of the first plurality of PDUs includes a length indicator with a value within a valid range.

30. The computer-readable medium of claim 26, further comprising code for determining whether the first plurality of PDUs and the second plurality of PDUs were correctly received based on status information of a STATUS PDU received from a receiving RLC entity or piggybacked status information received from the receiving RLC entity.
